(19) United States
(12) Patent Application Publication
(10) Pub. No.: US 2002/0147686 A1
(43) Pub. Date: Oct. 10, 2002

(54) Method and apparatus for a playback area network

(75) Inventors: Reem Safadi, Horsham, PA (US); Mark DePietro, Harleysville, PA (US)

Correspondence Address: RADER FISHMAN & GRAUER PLLC, LION BUILDING, 1233 20TH STREET N.W., SUITE 501, WASHINGTON, DC, 20036, US

(73) Assignee: General Instrument Corporation

(21) Appl. No.: 09/826,820

(22) Filed: Apr. 6, 2001

(51) Int. Cl. G06F 17/60

(52) U.S. Cl. 705/51

(57) ABSTRACT

The method and apparatus for distributing multimedia content over a network to a plurality of networked and portable devices affords a system operator the ability to control the unauthorized distribution and playback of content transferred by the system operator to a user of that system. The transferred content in the form of encrypted data is distributed over the network from a set-top terminal/personal versatile recorder to at least one playback device, in accordance with rights established by the system operator or the content provider, where the content is decrypted for subsequent playback by the authorized device (s). The method also addresses illegal propagation of content.

### CROSS REFERENCES TO RELATED APPLICATIONS

This application relates to subject matter disclosed in copending U.S. patent application Ser. No. ______, filed on ______.

### FIELD OF THE INVENTION

The present invention relates to a set-top terminal for connection to a communication network of a broadband system. More specifically, the present invention relates to the ability of distributing content to different devices in the home, automotive vehicle, or the office along with limiting the unauthorized distribution and playback of copyright-protected content.

### BACKGROUND OF THE INVENTION

Multimedia content includes audio recordings and audiovisual programming in the form of digital data. When audio recordings and audiovisual programming are formatted as digital data, conventional data compression formats enable the creation of digitized multimedia files.

One example of a data compression format is the Moving Pictures Experts Group (MPEG) level-2 data format, also known as the MPEG-2 video data compression format. This format can be used for the compression and decompression of digital bit streams that are broadcast over multi-channel video programming networks. Such networks include, but are not limited to cable, satellite and terrestrial networks. This content includes television broadcasts, webcasts, and streamed or non-streamed content, some of which is in the MPEG-2 format.

Another example of a conventional data compression format is the MPEG layer 3 data format, also known as the MP3 data format. By encoding an audio recording using the MP3 format, an audio data file can be reduced to one twelfth of its original size with only very little loss of audio quality. An MP3-encoded audio data file can be stored as a small file on a personal computer, or on another device known as a personal digital audio player. The personal digital audio player provides for the easy distribution of MP3 formatted music content by allowing a listener to download customized play-lists from over the Internet to the portable player. These players are generally accompanied with software that facilitates easy transfer of MP3 files between a platform such as a personal computer and the portable player. The portability of content along with the customization of such content to meet the preferences of the listener is becoming increasingly popular. As a result, players that do not enable these abilities are becoming less appealing to consumers.

Other forms of digitally-formatted multimedia content include, but are not limited to, Internet Protocol, picture and graphics files, HyperText Markup Language (HTML) files, Extended Markup Language (XML) files, application software files, electronic mail (e-mail), universal resource locator (URL) links, or any combination of the above.

However, there are shortcomings in the use of digitally-formatted multimedia content. For example, as the use and transfer of digitally-formatted multimedia content expand, concerns about the violation of the content owner's rights in copyrighted work continue to proliferate. Currently, copyright-protected content in digital form can be copied without limitation, resulting in the substantial risk of piracy known as “content piracy.” Content piracy is generally described as the unauthorized, unlawful reproduction or distribution of multimedia content. It is responsible for the loss of considerable revenue to the content owner and/or the distributor.

Consequently, there is a need in the art for a method and apparatus that allows the consumer to transfer content among multiple devices in a transparent manner, transparent to the content type and the devices involved, while limiting the distribution and further playback of the copyright-protected content.

### SUMMARY OF THE INVENTION

It is an object of the present invention to meet the above-described needs. Specifically, it is an overall object of the present invention to provide a portability of content via a versatile recorder that manages multimedia data in a wide variety of file and streaming formats.

Furthermore, it is an object of the present invention to provide an apparatus and method that affords a Multiple System Operator, the Internet Service Provider, or the content provider, (hereinafter referred to as the System Operator) the ability to limit the unauthorized distribution and reproduction of content transferred by the system operator over a delivery network to a user of the system.

The present invention is preferably embodied and described as a personal versatile recorder for recording any type of data.

The personal versatile recorder of the present invention is preferably integrated with a set-top terminal to share a common central processing unit; to share associated firmware and software, decoding and security elements, interfaces, and the like, as well as a data storage device; to share a connection for receiving audiovisual programming; and for receiving one or more data transport streams.

In accordance with the present invention, content in the form of encrypted data is distributed over a network from a set-top terminal/personal versatile recorder to at least one playback device.

When a user requests a transfer of some content from the set-top terminal/personal versatile recorder to storage/playback device (referred to here after as the playback device), the playback device, which is interfaced to the network, authenticates itself to the set-top terminal/personal versatile recorder prior to receiving the content. The content is transferred either as an encrypted stream or an unencrypted stream. An inquiry is made to determine the existence of permission to make copies of the content. A connection between the set-top terminal/personal versatile recorder and the playback device is established if the permission has been determined to exist. Identification is then provided from the playback device to the set-top terminal/personal versatile recorder.

Next, the playback device requests identification from the set-top terminal/personal versatile recorder. The set-top terminal/personal versatile recorder registers the playback device with the system operator in order to trace the content distributed to the playback device and performs a distribution inquiry to authenticate the playback identification and to determine if the playback device has permission to access the content. When playback identification is confirmed and the playback device has permission to access the content, a distribution identification code is provided to the playback device and the establishment of secure communications is requested. A playback inquiry to authenticate the distribution identification is performed and the set-top terminal/personal versatile recorder is instructed to begin transferring the content when the step of performing the playback inquiry yields a result that is sufficient for the establishment of a secure communications link. At that point, the content is transferred from the set-top terminal/personal versatile recorder to the playback device.

In another embodiment of the present invention, the set-top terminal/personal versatile recorder located at a location is interfaced to a playback device. The user requests a transfer of content from the set-top terminal/personal versatile recorder to the playback device and a playback identifier is reported to a system operator, wherein the system operator checks the playback identifier against a revocation list.

Another object of the present invention is to provide a method and apparatus for permitting the access to content and the duplication of content. This permission is offered by a system operator as an option that is selectable by the set-top terminal/personal versatile recorder. The right to perform the option is granted by the system operator, where such rights may correspond to the rights established by the content provider or a distributor on behalf of the content provider, to the set-top terminal/personal versatile recorder. Once the option is executed, the access to content and the duplication of content are tracked and reported to the system operator for additional billing.

It is an object of the present invention to meet the above-described needs. Specifically, it is an overall object of the present invention to provide a versatile recorder that manages multimedia data in a wide variety of file and streaming formats.

Furthermore, it is an object of the present invention to provide a method and apparatus that affords a system operator the ability to limit the unauthorized distribution and playback of content transferred by the system operator to a user of the system.

Additional objects, advantages and novel features of the invention will be set forth in the description which follows or may be learned by those skilled in the art through reading these materials or practicing the invention. The objects and advantages of the invention may be achieved through the system, apparatus, methods, or means recited in the attached claims.

These and other objects, advantages, aspects and features of the present invention will be more fully understood and appreciated upon consideration of the following detailed description of a preferred embodiment, presented in conjunction with the accompanying drawings.

### BRIEF DESCRIPTION OF THE DRAWINGS

The accompanying functional drawings illustrate the present invention and are a part of the specification. Together with the following description, the drawings demonstrate and explain the principles of the present invention.

FIG. 1 is a block diagram of the diagram of a playback area network according to the present invention.

FIG. 2 is a flowchart outlining the retrieval of according to the present invention.

FIG. 3 is a block diagram of the apparatus for distributing content according to the present invention.

FIG. 4 is a block diagram of the apparatus for distributing content according to an alternative embodiment of the present invention.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It being understood that various changes may be made in the function and arrangement of elements without departing from the spirit and scope of the invention.

Using the drawings, the preferred embodiments of the present invention will be explained. These functional embodiments are illustrative in nature and chosen for exposition of the principles of the present invention. The invention is not, however, limited to the following embodiments, as will be appreciated by those skilled in the art.

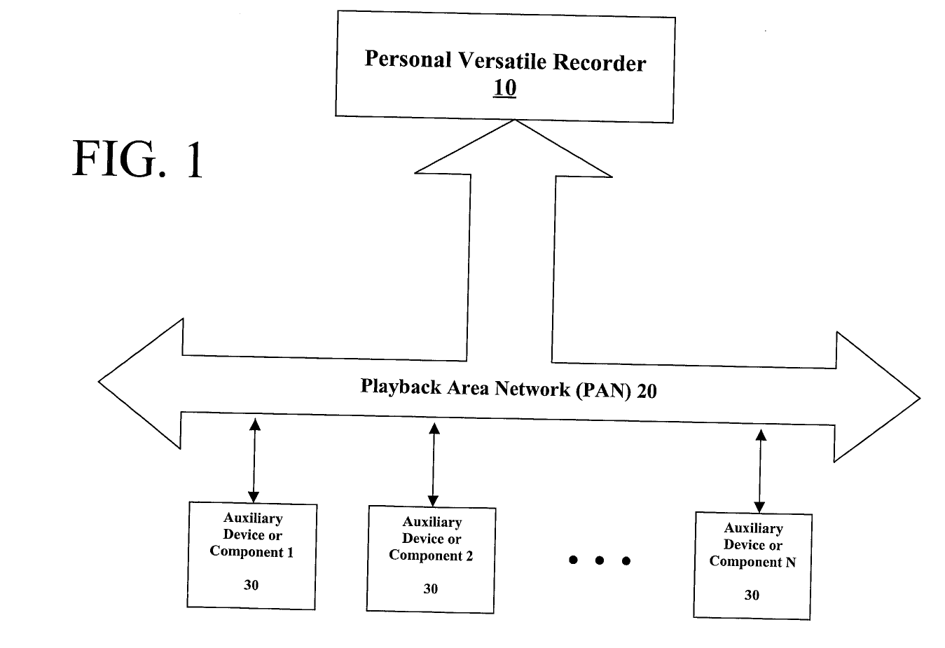

FIG. 1 depicts an apparatus of the present invention that includes the Personal Versatile Recorder (10), the Playback Area Network (PAN)(20), and at least one receiver/playback device (30).

The Personal Versatile Recorder (10) of the present invention is a digital compression device that functions as a caching and distribution gateway for the transfer of multimedia content from the system operator and affiliated content providers. This device provides the integrated capacity to store, replay, retrieve, and distribute content. Multimedia content includes, but is not limited to, audiovisual programming such as compressed or pre-compressed programming. Audiovisual programming is not limited to a single video stream, e.g., a single camera angle, but can also include user-selectable multiple camera angles. Similarly, multimedia content also includes audio in the form of multiple user-selectable audio streams. Furthermore, the audiovisual programming, analog programming, digital broadcast or on-demand MPEG-2 programming, or webcast streaming media are all sources of multimedia content. This content also includes video files, picture and graphics files, audio files, HTML files, XML files, text files, application software files, e-mail, URL links, and the like.

The Personal Versatile Recorder (10) is either integrated into a set-top terminal or is housed separately as a stand-alone unit. While FIG. 1 depicts the Personal Versatile Recorder (10) as the distribution device of the preferred embodiment, any device with such distribution capabilities is suitable as an alternative to the Personal Versatile Recorder (10). Thus, the use of this alternative device in place of the Personal Versatile Recorder (10), whether the receiver/playback device (30) is located within or outside of the residence, is practicable as an extension to the embodiment of the present invention.

The PAN (20) is a wired or a wireless network that is suitable for transporting multimedia content from the Personal Versatile Recorder (10) to the receiver/playback device (30). This content is transported from the Personal Versatile Recorder (10) to the receiver/playback device (30). The content is transferred either as an encrypted stream or an unencrypted stream.

The receiver/playback device (30), interfaced to the PAN (20), comprises any number of devices that include, but are not limited to a personal computer, an optical disk player such as a compact disc (CD) player and a digital video disc (DVD) player, a portable player such as a personal digital audio player and an MP3 player, a video player, a hand-held computer, a cell phone or other personal communication devices, and any other device capable of receiving a digital bit stream.

Content Rights Management prevents the illegal or unauthorized reproduction, duplication or transmission of multimedia content. Using Content Rights Management, the Personal Versatile Recorder (10) possesses the ability to store multimedia content and to transfer the content to another receiver/payback device (30) over the PAN (20) pursuant to the content owner's and/or the distributor's rights in the copyrighted work. Content Rights Management provides an approach for sanctioning and tracing operations performed on the content, such as viewing, displaying, or reproducing the content, or forwarding the content to another user; and for sanctioning and tracing transactions on the content, such as setting conditions for granting access and accepting payment for content. Content Rights Management also provides a framework for specifying the frequency and duration of the operations and transactions that are performed on the content. Content Rights Management includes capabilities such as those described under the Secure Digital Music Initiative (SDMI) or alternative Content Rights Management systems.

In addition to Content Rights Management, the content is transferred in an encrypted format from the system operator's facilities to the Personal Versatile Recorder (10) to assist in preventing prohibited or unlicensed access to the multimedia content. The content is decrypted upon receipt from the delivery network either for playback by the Personal Versatile Recorder (10), or for re-encryption by the Personal Versatile Recorder (10) to distribute the content over the PAN (20). The secure transfer of the content from the Personal Versatile Recorder (10) to a receiver/playback device (30) is established using a standard protocol. This protocol may include, but is not limited to, the Secure Sockets Layer (SSL) protocol.

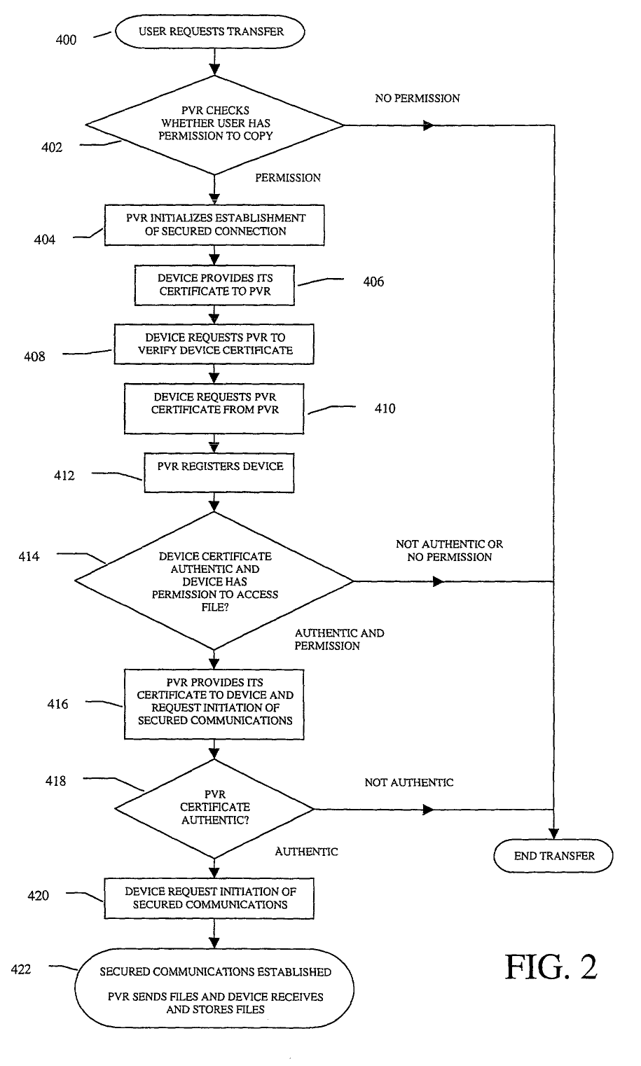

Content is distributed over the PAN (20) using the transfer scheme as shown in the flowchart of FIG. 2. The scheme includes, but is not limited to a Public-Key Encryption format along with a digital certificate such as an X.509 certificate, or the like. When a Public-Key Encryption format is used for encryption and decryption, the keys used to encrypt and decrypt the content are specific to a particular personal versatile recorder. The private-public key pair is stored securely in hardware located within the Personal Versatile Recorder (10) to prevent access to the pair, while storage of the certificate in a non-secure medium, such as non-secure memory, is feasible.

The corresponding public key and certificates for the receiver/playback device (30) are transferred to the receiver/playback device (30) from the Personal Versatile Recorder (10). The private key for the receiver/playback device (30) is required by the receiver/playback device (30) to decrypt the content. This scheme prevents the use of transferred content by an illegal or unauthorized receiver/playback device (30). In particular, this transfer is not initiated until the requisite authorization, pursuant to restraints such as Content Rights Management, is validated. Since an illegal or unauthorized receiver/playback device (30) will be unable to decrypt the content, the encryption/decryption scheme obviates the need for physically mating the receiver/playback device (30) to the Personal Versatile Recorder (10).

When direct connectivity among the transferring and receiving devices is present, a feature of the present invention provides for the issuance of challenge/response commands. These commands provide for additional transfer security while safeguarding the authenticity of the communicating devices.

Initially, as shown in step 400 of FIG. 2, the user requests the transfer of content from the Personal Versatile Recorder (10) to a receiver/playback device (30). When the multi-channel video programming network is a cable network, the Personal Versatile Recorder (10) communicates with the headend to determine if a receiver/playback device (30) is approved for use on the PAN (20) if this approval is either desired or required by the content owner and/or the distributor.

In step 402, when the requested content is a copyrighted work, the Personal Versatile Recorder (10) performs an inquiry to determine whether the user has permission to make copies of that work and whether the maximum number of copies allowed has not been exceeded, if such a limit has been specified. If the requisite permissions exist, the Personal Versatile Recorder (10) initializes the establishment of an SSL connection with the receiver/playback device (30), as shown in step 404.

Next, the receiver/playback device (30) authenticates itself to the Personal Versatile Recorder (10) by providing a certificate to the Personal Versatile Recorder (10), as shown in step 406 of FIG. 2, and by requesting verification of that certificate, as shown in step 408. In step 410, the receiver/playback device (30) then requests a certificate from the Personal Versatile Recorder (10).

The Personal Versatile Recorder (10) registers the receiver/playback device (30), in step 412, for a subsequent “reportback” to trace any content that has been distributed to the device (30). Next, as shown in step 414, the Personal Versatile Recorder (10) performs an inquiry to authenticate the certificate provided by the receiver/playback device (30) and determines if the receiver/playback device (30) has permission to access the requested content. If the inquiry and the determination are sufficient, then, the Personal Versatile Recorder (10) provides its certificate to the receiver/playback device (30) and requests the establishment of secure communications, as shown in step 416.

As shown in step 418, the receiver/playback device (30) then performs an inquiry to authenticate the certificate provided by the Personal Versatile Recorder (10). If the result of this inquiry is sufficient for the establishment of a communications link, then the receiver/playback device (30) will perform step 420 of instructing the Personal Versatile Recorder (10) to begin transferring the content.

At this point, in step 422, the secure channel is established over the PAN (20) to transfer the content from the Personal Versatile Recorder (10) to the receiver/playback device (30) using the standard protocol. The receiver/playback device (30) will either store the content for later use or decrypt the content for playback.

In another embodiment of the present invention, system operator establishes that the Personal Versatile Recorder (10) is located at a particular user residence or location. In accordance with this alternative embodiment, the content that has been designated for transfer to the Personal Versatile Recorder (10) is stored or reproduced only by an receiver/playback device (30) that is associated with the particular user residence or location. This alternative embodiment proceeds as follows.

Initially, a receiver/playback device (30) owned by a user is interfaced to the Personal Versatile Recorder (10) that is located at a user residence or location. The user then requests the transfer of content from the Personal Versatile Recorder (10) to a receiver/playback device (30). Using a standard protocol, the identifier for the receiver/playback device (30) is reported to the system operator. This identifier may comprise, but is not limited to, an X.509 certificate. The system operator compares the identifier against a nationally known revocation list of prohibited devices. Alternatively, the revocation list of a limited number of prohibited devices is stored in the Personal Versatile Recorder (10). If identifier is not on the revocation list and has not been previously associated with any other set-top terminal, the identifier is then registered and associated with the Personal Versatile Recorder (10). The system operator sends an acknowledgement to the Personal Versatile Recorder (10) indicating the association of the Personal Versatile Recorder (10) with the receiver/playback device (30). But if the identifier is on the revocation list, then the association of the Personal Versatile Recorder (10) with the receiver/playback device (30) is denied and the system operator sends a negative acknowledgement to the Personal Versatile Recorder (10). Upon receipt of this negative acknowledgement, the Personal Versatile Recorder (10) terminates the transfer request.

If the identifier of the receiver/playback device (30) is associated with a Set-Top Terminal other than the Personal Versatile Recorder (10), the system operator flags the identifier for further investigation. The transfer is aborted when a negative acknowledgement, indicating a denial of the association of the Personal Versatile Recorder (10) with the receiver/playback device (30), is sent from the system operator to the Personal Versatile Recorder (10). Conversely, the transfer is permitted when a positive acknowledgement is sent, indicating an authorization of the association of more than one Personal Versatile Recorder (10) with a specific receiver/playback device (30).

These features are controllable by the system operator. For example, medium to high value content may be offered only from the system operator for a certain release window, that allows the consumer to access this content with selected playback options (copy never, copy once, copy without restrictions) at different price points. Two grades of content are offered, one for mass consumption and one for production, such that if the former were stolen it would not play on an unauthorized device.

In yet another embodiment of the present invention, an embedded selfdestruction feature contained within the content communicates with the receiver/playback device (30) and the system operator. The activation of this routine occurs under detection of certain conditions that include, but are not limited to, an unauthorized access of the content or a copyright violation. Upon activation of the self-destruction feature, the identifier of the receiver/playback device (30) obtained by the Personal Versatile Recorder (10) and a signed token for traceability is generated (with all relevant information), stored locally on the Personal Versatile Recorder (10), and is reported to the system operator. This feature includes, but is not limited to, the anonymous server tasked to investigate the unauthorized conditions that initiate an activation of the embedded self-destruction feature. This server is operated by the system operator or by a third party. The signed token ensures reporting authenticity and non-repudiation. In addition to this reporting feature, the content is erased from the memory contained within the Personal Versatile Recorder (10). The signed token also is maintained for subsequent use. The user may also receive a warning indicating that any further infraction may result in a fine or an arrest. This warning is stored within the device (30), either as a message generated by the device (30), or alternatively, as a message provided from the system operator for the subsequent presentation by the device (30) to the user.

Revenue collection is in accordance with the business agreements that the system operator placed with the content owners. Collection is as follows.

Initially, the user selects one of the access and copy options offered by the system operator for a given content. The right to perform the selected option is granted to the Personal Versatile Recorder (10). Billing may occur at this time or may be deferred. The user exercises these options. The Personal Versatile Recorder (10) then tracks the options as they are exercised and reports the options to the system operator for additional tracking or billing. The above is only an example embodiment other embodiments are also possible.

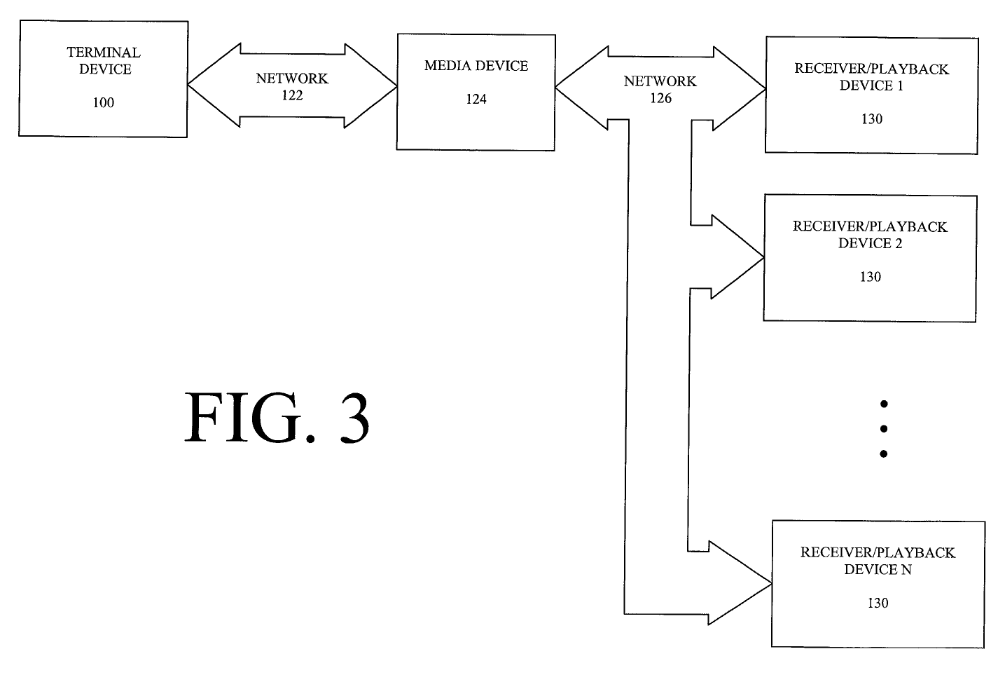

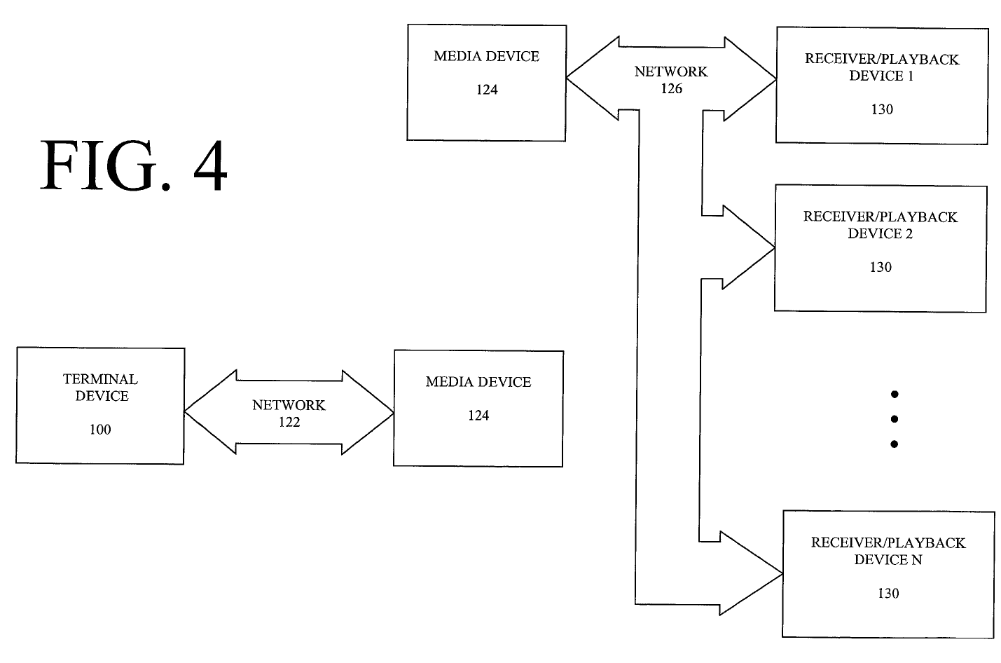

Depicted within FIG. 3 and FIG. 4 are a transmitting device (100), a network (122), a media device (124), a network (126), and at least one receiver/playback device (130). The transmitting device (100) of the present invention includes, but is not limited to the Personal Versatile Recorder (10) as described hereinabove, a Set-Top Terminal, a personal computer (PC), or any device that can output information in the form of a digital or analog signal.

The network (122) includes, but is not limited to the PAN (20) as described hereinabove, or any network that is suitable for transferring information from the transmitting device (100) to a media device (124), such as a wired network or a wireless network.

The media device (124) includes, but is not limited to, the receiver/playback device (30) as described hereinabove, a stationary device capable of storing content, a mobile or portable device capable of storing content, a removable storage medium, a portable storage medium, a secure digital card, an optical disc, a magnetic disc, a floppy diskette, either as a stand-alone unit or as part of another stationary or portable device.

Similar to the network (122), the network (126) includes, and is not limited to the PAN (20) as described hereinabove, or any network that is suitable for transporting information from the media device (124) to at least one receiver/playback device (130).

The receiver/playback device (130) includes, but is not limited to, the receiver/playback device (30) as described hereinabove, a transmitting device (100) that is also capable of receiving content, a media device (124), or any other device capable of receiving content. The receiver/playback device (130) is co-located with or remotely-located from the transmitting device (100). The media device (124) is a conduit for the ultimate content distribution to the receiver/playback device (130). Specifically, instead of using direct wired or wireless networking from the transmitting device (100) to the receiver/playback device (130) for the transfer multimedia content, the media device (124) is alternatively used to as an intermediary the transmitting device (100) and the a receiver/playback device (130) for the transfer of this content.

FIG. 3 depicts the media device (124) as being simultaneously interfaced with the transmitting device (100) and the receiver/playback device (130).

Alternatively, FIG. 4 depicts the media device (124) that is not simultaneously interfaced with the transmitting device (100) and the receiver/playback device (130). Instead, the media device (124) is initially interfaced with the transmitting device (100), receiving content transferred therefrom. The transferred content received from the transmitting device (100) is stored in the storage medium of the media device (124) for subsequent delivery to the receiver/playback device (130). The media device (124) is then isolated from the transmitting device (100) and interfaced with the receiver/playback device (130). Once the media device (124) is interfaced with the receiver/playback device (130), the transferred content stored in the storage medium of the media device (124) is then transported to the receiver/playback device (130). As shown within FIG. 4, co-location of the receiver/playback device (130) and the transmitting device (100), while being feasible, is not a prerequisite for the transfer of content from the transmitting device (100) to the receiver/playback device (130). Instead, the receiver/playback device (130), being remotely-located from and not directly interfaced with the transmitting device (100) will nevertheless receive content from the transmitting device (100).

The apparatus FIG. 3 and FIG. 4 performs various functions to enhance the performance of the media device (124) and/or the receiver/playback device (130) once direct or indirect communication using a wired or wireless interface between these devices and the transmitting device (100) has been established. These functions include, but are not limited to, the enablement and disablement of the configuration, the administration, and the programming or reprogramming of the media device (124) and/or the receiver/playback device (130).

These performance-enhancing functions also include the enablement and disablement of the information transfer from the transmitting device (100) to the media device (124) and/or the receiver/playback device (130). Using the apparatus of FIGS. 3 and 4, multimedia content is transferred from the transmitting device (100) to the media device (124) using the transfer scheme shown in the flowchart of FIG. 2 and described hereinabove. Furthermore, each transmitting device (100), media device (124), and receiver/playback device (130) contains secure agents, which are applications written in software and may be supported via secured hardware resources, that permit these devices to perform Content Rights Management functions. In particular, an additional level of security is achieved by programming the media device (124) to facilitate data transfer to the receiver/playback device (130) only after the media device (124) has coordinated the transfer with the transmitting device (100) and has successfully authenticated the receiver/playback device (130). This programming is accomplished through an agent that is included as a feature of the transmitting device (100) and another agent that is included as a feature of the media device (124). The agent that is included with the transmitting device (100) provides to the transmitting device (100) the ability to configure and send, to the media device (124), information for permitting the establishment of a communications link with a selected receiver/playback device (130). This information includes, but is not limited to, the requisite the public keys and associated certificates. The agent that is included with the media device (124) provides to the media device (124) the ability to receive the information from the transmitting device (100) and to store the public keys and associated certificates of the media device (124) and the receiver/playback device (130). These agents also permit the user to transfer content from various media devices (124) to diverse receiver/playback devices (130) when the media device (124) is programmed to have the same security features, such as keys, certificates, or supporting cryptography routines, as any other receiver/playback device. The media device (124) disallows the transfer of data in the same manner as the transmitting device (100) when the media device (124) detects an illegal or unauthorized device as the receiver/playback device (130).

The preceding description has been presented only to illustrate and describe the invention. It is not intended to be exhaustive or to limit the invention to any precise form disclosed. Many modifications and variations are possible in light of the above teaching.

The preferred embodiments were chosen and described to explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. An apparatus for distributing content over a network, comprising:
a distribution means interfaced to said network for distributing content onto said network, and at least one playback means interfaced to said network for receiving said distributed content,
wherein said distribution means:
determines the existence of permission to make copies of said content;
registers said at least one playback means to trace said content distributed to said at least one playback means;
authenticates said at least one playback means;
determines if said at least one playback means has permission to access said content;
requests an initiation of secure communications; and
transfers said content from said distribution means to said at least one playback means; and
wherein said at least one playback means:
authenticates said distribution means;
instructs said distribution means to begin transferring said content; and
stores said distributed content transferred from said distribution means.

2. The apparatus of claim 1, wherein:
said at least one playback means includes storage means for storing said distributed content.

3. The apparatus of claim 1, wherein:
said at least one playback means provides identification to said distribution means to authenticate said at least one playback means.

4. The apparatus of claim 1, wherein:
said distribution means provides identification to said at least one playback means to authenticate said distribution means.

5. A method for distributing multimedia content over a network, the method comprising:
requesting a transfer of said content;
determining the existence of permission to make copies of said content;
providing playback means identification from a playback means to a distribution means;
requesting said distribution means to authenticate said playback means;
requesting distribution means identification from said distribution means, said distribution means identification being requested by said playback means;
registering said playback means to trace said content distributed to said playback means, said step of registering being performed by said distribution means;
authenticating said playback means;
determining if said playback means has permission to access said content;
providing said distribution means identification to said playback means;
requesting an initiation of secure communications;
authenticating said distribution means;
instructing said distribution means to begin transferring said content; and
transferring said content from said distribution means to said playback means.

6. The method of claim 5 wherein:
said content is transfer-red from said distribution means to said playback means.

7. The method of claim 5 wherein:
said distribution means is a personal versatile recorder.

8. The method of claim 5 wherein:
said playback means is a device that is compatible with said network.

9. The method of claim 5 wherein:
said content is at least one copyrighted work.

10. The method of claim 5 wherein:
said content is encrypted by said distribution means.

11. The method of claim 5 wherein:
said connection is a link using a communications protocol.

12. The method of claim 5 wherein:
said distribution means identification is a certificate

13. The method of claim 5 wherein:
said playback means identification is a certificate.

14. The method of claim 5 wherein:
said local area network is a wireless network.

15. The method of claim 5 wherein:
said step of determining the existence of permission for said playback means to access said content is performed by said distribution means.

16. The method of claim 5 wherein an embedded self-destruction feature is contained within said content, said method further comprising the steps of:
determining whether a self-destruction feature is to be activated, wherein upon activation of said self-destruction feature,
a) said playback means identification is reported to a system operator, and
b) said content is erased from said distribution means.

17. A method for distributing multimedia content over a network, the method comprising:
interfacing a playback means owned by a user to a distribution means, said distribution means is located at a location;
requesting a transfer of content from said distribution means to said playback means;
reporting a playback identifier to a system operator, wherein said system operator checks said playback identifier against a revocation list.

18. The method of claim 14 wherein when said playback identifier is not on said revocation list and has not been previously associated with any other distribution means, said method further comprising the steps of:
registering said playback identifier;
associating said playback identifier with said distribution means; and
sending an acknowledgement from said system operator to said distribution means indicating the association of said distribution means with said playback means.

19. The method of claim 14 wherein when said playback identifier is on said revocation list, said method further comprising the steps of:
sending a negative acknowledgement from said system operator to said distribution means, said negative acknowledgement indicating a denial of the association of said distribution means with said playback means, said distribution means terminating the transfer request.

20. The method of claim 14 wherein when said playback identifier is associated with a distribution means other than said distribution means, said method further comprising the steps of:
sending a negative acknowledgement from said system operator to said distribution means, said negative acknowledgement indicating a denial of the association of said distribution means with said playback means, said distribution means terminating the transfer request.

21. The method of claim 14 wherein:
said playback identifier is an identifier for said playback means.

22. The method of claim 14 wherein:
said playback identifier is an X.509 certificate.

23. The method of claim 14 wherein:
said step of reporting further comprises using a standard protocol.

24. The method of claim 14 wherein:
said playback means is one of at least one device.

25. The method of claim 14 wherein:
said distribution means is set-top terminal.

26. The method of revenue collection comprising:
selecting at least one option offered by a system operator, said at least one option is one of an access option and a copy option;
granting to a distribution means a right to perform said at least one option by said system operator;
executing said at least one option;
tracking the execution of said at least one option;
reporting said at least one option to said system operator for additional billing.
